(19) United States
(12) Patent Application Publication
(10) Pub. No.: US 2026/0366930 A1
(43) Pub. Date: Nov. 19, 2026

(54) EVALUATING METHOD AND MEASURING DEVICE FOR FICTIVE TEMPERATURE OF OPTICAL FIBER

(71) Applicant: NTT, Inc., Tokyo (JP)

(72) Inventors: Kohei OMOTO, Musashino-shi, Tokyo (JP); Kazuhide NAKAJIMA, Musashino-shi, Tokyo (JP); Takashi MATSUI, Musashino-shi, Tokyo (JP)

(73) Assignee: NTT, Inc., Tokyo (JP)

(21) Appl. No.: 19/139,890

(22) PCT Filed: Feb. 20, 2023
(86) PCT No.: PCT/JP2023/006000

§ 371 Date: Jun. 17, 2025

(51) Int. Cl. G01K 11/324; G01N 21/65

(52) U.S. Cl. CPC G01K 11/324; G01N 21/65

(57) ABSTRACT

An evaluating method and a measuring device for a fictive temperature of an optical fiber are related to a measuring device including a light source that irradiates an end face of an optical fiber mainly made of quartz glass with excitation light; a spectrophotometer that detects a spectrum of light emitted from the end face, and a controller that analyzes the spectrum, wherein a peak intensity of Raman scattered light ω3 is subtracted from an intensity of the spectrum to calculate a corrected spectrum, a peak intensity of Raman scattered light D2 normalized by a peak intensity of reference Raman scattered light due to Si—O—Si skeletal vibration contained in the corrected spectrum is acquired, and the fictive temperature is estimated using a correlation established between the peak intensity of the Raman scattered light D2 and a fictive temperature of the quartz glass.

TECHNICAL FIELD The present disclosure relates to an evaluating method and a measuring device for the fictive temperature of an optical fiber.

### BACKGROUND ART

Non Patent Literature 1 discloses that the transparency of the glass that constitutes an optical fiber correlates with a fictive temperature TF, which is the temperature at which the glass freezes. By evaluating the fictive temperature TF with high accuracy, the manufacturing conditions of the glass can be optimized.

Non Patent Literature 2 to 4 disclose that the fictive temperature TF of quartz glass depends on the D2 peak intensity of the Raman scattering spectrum.

In general, it is difficult to evaluate the absolute value of a spectrum's peak intensity because it is affected by fluorescence and background light. Therefore, when evaluating a peak intensity, it is necessary to perform an evaluation using appropriate analytical processing.

Non Patent Literature 2 discloses a method of evaluating the D2 peak intensity by performing non-linear fitting to separate the peaks. Non Patent Literature 3 discloses a method of evaluating the area of the D2 peak intensity by normalizing it with the area of the ω3 peak intensity, which is less susceptible to the influence of the fictive temperature TF.

### CITATION LIST

### Non Patent Literature

[Non Patent Literature 1] K. Saito et al., Journal of the American Ceramic Society, vol.89, no.1, pp.65-69 (2006).
[Non Patent Literature 2] N. Shimodaira et al., Appl. Phys. Lett., vol. 91, pp. 3522-3525 (2002).
[Non Patent Literature 3] Y. Tamura et al., J. Lightw. Technol., vol. 36, no. 1, pp. 44-49 (2018).
[Non Patent Literature 4] G. S. Henderson et al., J. Non. Cryst. Solids, vol. 355, pp.468-474 (2009).

### SUMMARY OF THE INVENTION

### Technical Problem

The method disclosed in Non Patent Literature 2 has the problem that the analytical processing becomes complicated because peak separation is performed by performing non-linear fitting. Furthermore, the method disclosed in Non Patent Literature 3 has the problem that the reproducibility of deriving peak areas decreases due to differences in a selected range of peak areas or the influence of peak shifts.

The present disclosure has been made to address such problems. An object of the present disclosure is to provide an evaluating method and measuring device for the fictive temperature of an optical fiber, which can easily and accurately evaluate the fictive temperature of the glass that constitutes the optical fiber.

### Solution to Problem

In order to solve the problems above, according to one aspect of the present disclosure, an evaluating method and a measuring device for a fictive temperature of an optical fiber are related to a measuring device including a light source that irradiates an end face of an optical fiber mainly made of quartz glass with excitation light; a spectrophotometer that detects a spectrum of light emitted from the end face, and a controller that analyzes the spectrum. A peak intensity of Raman scattered light ω3 is subtracted from an intensity of the spectrum to calculate a corrected spectrum. A peak intensity of Raman scattered light D2 normalized by a peak intensity of reference Raman scattered light due to Si—O—Si skeletal vibration contained in the corrected spectrum is acquired. Then, the fictive temperature is estimated using a correlation established between the peak intensity of the Raman scattered light D2 and a fictive temperature of the quartz glass.

### ADVANTAGEOUS EFFECTS OF INVENTION

According to the present disclosure, the fictive temperature of the glass that constitutes an optical fiber can be evaluated easily and with high accuracy.

### BRIEF DESCRIPTION OF DRAWINGS

FIG. 1 is a diagram illustrating a schematic configuration of a measuring device according to one embodiment of the present disclosure.

FIG. 2 is a flowchart illustrating an overview of processing of the measuring device according to one embodiment of the present embodiment.

FIG. 3 is a diagram illustrating one example of a spectrum of Raman scattered light emitted from an end face of an optical fiber mainly made of quartz glass.

FIG. 4 is a diagram illustrating one example of a ratio of peak intensity to fictive temperature.

FIG. 5 is a diagram illustrating one example of a ratio of peak area to fictive temperature based on related art.

FIG. 6 is a diagram illustrating a hardware configuration of a controller.

### DESCRIPTION OF EMBODIMENTS

Embodiments of the present disclosure will be described in detail below with reference to the drawings. In the descriptions, same portions are assigned the same reference numerals, and descriptions thereof are omitted accordingly.

### Configuration of Measuring Device

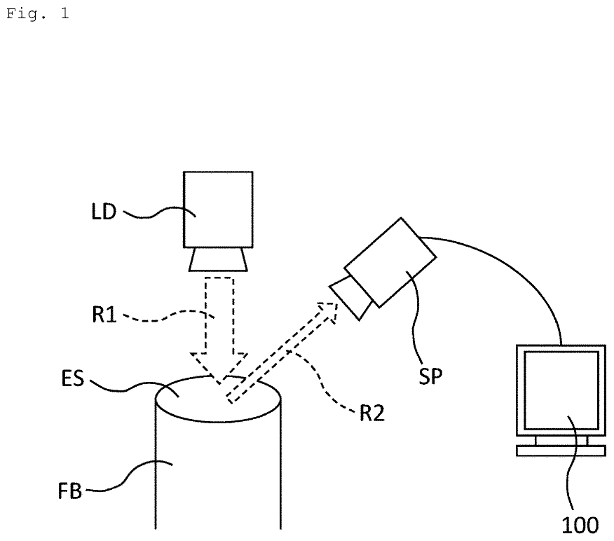

FIG. 1 is a diagram illustrating a schematic configuration of a measuring device according to the present embodiment. As shown in FIG. 1, the measuring device includes a light source LD, a spectrophotometer SP, and a controller 100. A relative positional relationship between the light source LD and the optical fiber FB is fixed so that an end face ES of an optical fiber FB that is to be measured by the measuring device is irradiated with excitation light R1 from the light source LD. The relative positional relationship between the spectrophotometer SP and the optical fiber FB is fixed so that scattered light R2 from the end face ES is incident on the spectrophotometer SP.

It should be noted that the optical fiber FB is made of a material whose main component is quartz glass. The optical fiber FB may be doped with impurities.

The light source LD outputs the excitation light R1 toward the end face ES of the optical fiber FB in order to excite molecular vibrations in the material that constitutes the optical fiber FB.

Generally, when a material is irradiated with light, the interaction between the light and the material causes a phenomenon called scattering in addition to reflection, refraction, and absorption. There are two types of scattering: Rayleigh scattering (elastic scattering), in which light of the same wavelength as the incident light is scattered, and Raman scattering (inelastic scattering), in which molecular vibrations cause light to be scattered to a wavelength different from the incident light. Raman scattered light is weaker than Rayleigh scattered light, and by dispersing the Raman scattered light to acquire its spectrum, it is possible to analyze the molecular-level structure within the optical fiber FB.

To acquire the Raman scattered light, the light source LD may be a monochromatic laser light source. In particular, since the Raman scattered light is weak light, it is desirable for the light source LD to be a high-intensity light source in order to increase the intensity of the Raman scattered light.

The spectrophotometer SP detects the spectrum of light emitted from the end face ES of the optical fiber FB. In particular, the spectrophotometer SP disperses the Raman scattered light emitted from the end face ES when the end face ES is irradiated with excitation light R1, and acquires the spectrum of the Raman scattered light.

The spectrophotometer SP may include a filter for removing Rayleigh scattered light contained in the scattered light R2, a diffraction grating for dispersing the Raman scattered light that has passed through the filter, and a charge coupled device (CCD) detector for detecting the dispersed light by wavelength.

The controller 100 is connected to a spectrophotometer SP and analyzes the spectrum of light emitted from the end face ES of the optical fiber FB.

A computer program is installed in the controller 100 to function as an analysis means for analyzing a spectrum. By executing the computer program, the controller 100 functions as a plurality of information processing circuits. The computer program may be stored on a recording medium that can be read and written by a computer, or may be provided via a network.

In the present embodiment, an example is shown in which multiple information processing circuits are implemented by software. However, it is also possible to configure an information processing circuit by preparing dedicated hardware for executing each of the information processes shown below. Furthermore, multiple information processing circuits may be configured by individual hardware.

The controller 100 calculates a corrected spectrum by subtracting the peak intensity of Raman scattered light ω3 due to Si—O stretching vibration contained in the spectrum from the intensity of the spectrum.

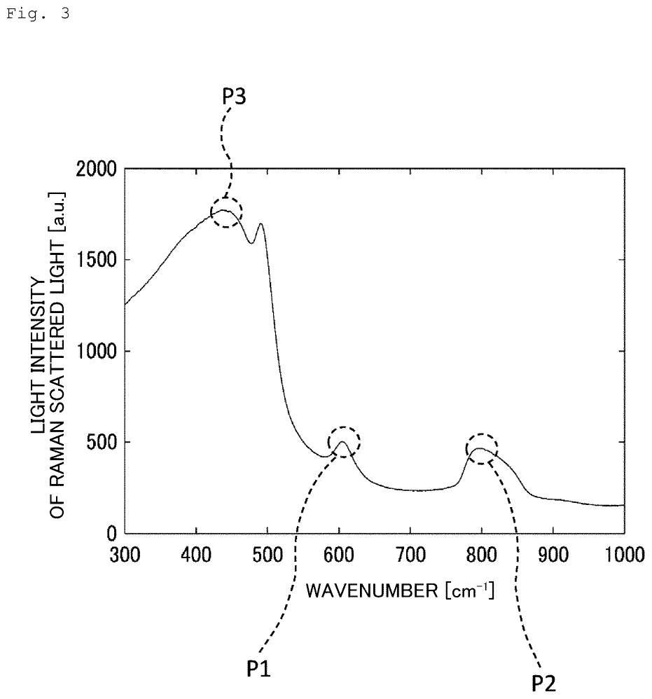

FIG. 3 is a diagram illustrating one example of the spectrum of the Raman scattered light emitted from the end face of the optical fiber mainly made of quartz glass. For example, the controller 100 acquires the peak intensity (intensity of peak P2) of the Raman scattered light ω3 located near a wavenumber of 800 cm⁻¹. Then, the controller 100 subtracts the peak intensity of the Raman scattered light ω3 from the entire spectrum of the Raman scattered light. Thus, the controller 100 changes the offset of the spectrum of the Raman scattered light and calculates a corrected spectrum.

Next, the controller 100 normalizes the corrected spectrum based on the peak intensity of the reference Raman scattered light due to the Si—O—Si skeletal vibration contained in the corrected spectrum. The controller 100 then acquires the peak intensity of the Raman scattered light D2 due to the 3-membered silica ring contained in the normalized corrected spectrum.

For example, in FIG. 3, the controller 100 acquires the peak intensity (intensity of peak P3) of the reference Raman scattered light located near a wavenumber of 400 cm⁻¹. The peak intensity of the reference Raman scattered light is acquired based on the corrected spectrum after the offset change.

The controller 100 then divides the intensity of the corrected spectrum by the peak intensity of the reference Raman scattered light to calculate a corrected spectrum normalized by the peak intensity of the reference Raman scattered light. The normalized corrected spectrum indicates the peak intensity ratio of the Raman scattered light to the peak intensity of the reference Raman scattered light. Based on the normalized corrected spectrum, the controller 100 acquires the peak intensity ratio of the peak intensity of Raman scattered light D2 (the intensity of peak P1) to the peak intensity of the reference Raman scattered light.

The controller 100 performs the above-mentioned process on multiple samples generated by subjecting the same type of optical fiber as the optical fiber to be measured to heat treatment at different heating temperatures and then rapidly cooling. The heating temperature differs for each sample. The controller 100 calculates a normalized correction spectrum for each sample and acquires the peak intensity of the Raman scattered light D2based on the normalized correction spectrum.

As a result, the controller 100 can acquire the peak intensity of the Raman scattered light D2 of the sample corresponding to different heating temperatures. The controller 100 then acquires a calibration curve showing the correlation based on the correlation between the heating temperature and the peak intensity of the Raman scattered light D2. Since each sample is rapidly cooled after the heating process, the heating temperature of the sample can be regarded as the fictive temperature TF of the sample.

The controller 100 estimates the fictive temperature TF of the optical fiber FB to be measured, whose fictive temperature TF is unknown, based on the correlation represented by the acquired calibration curve. In other words, the controller 100 estimates the fictive temperature TF using the correlation that exists between the peak intensity of the Raman scattered light D2 and the fictive temperature TF of the quartz glass.

### Processing Procedure of Measuring Device

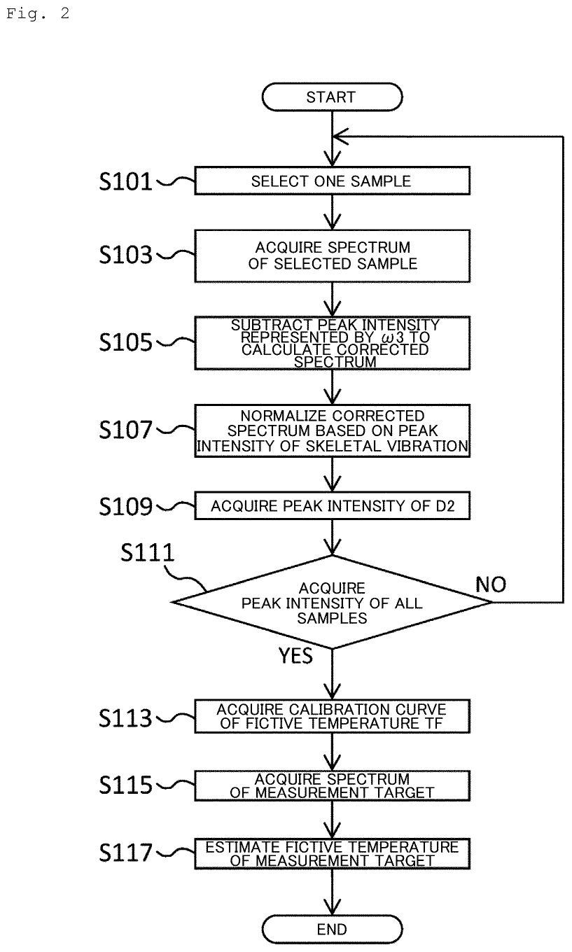

FIG. 2 is a flowchart illustrating an overview of processing of the measuring device according to the present embodiment. The process shown in FIG. 2 may be performed for multiple samples after a spectrum is acquired for each sample via the spectrophotometer SP, or may be performed each time a spectrum is acquired for a sample.

In step S101, the controller 100 selects one sample to be processed from the multiple samples.

In step S103, the controller 100 acquires the spectrum of the selected sample. For example, the controller 100 may read the spectrum from a storage device such as a database (not shown), or may read the spectrum from the spectrophotometer SP.

In step S105, the controller 100 calculates a corrected spectrum of the selected sample by subtracting the peak intensity of the Raman scattered light ω3. That is, the controller 100 acquires the peak intensity of the Raman scattered light ω3 and subtracts the peak intensity of the Raman scattered light ω3 from the entire spectrum of the Raman scattered light.

In step S107, the controller 100 normalizes the corrected spectrum of the selected sample based on the peak intensity of the skeletal vibration. That is, the controller 100 normalizes the corrected spectrum based on the peak intensity of the reference Raman scattered light due to Si—O—Si skeletal vibration contained in the corrected spectrum.

In step S109, the controller 100 acquires the peak intensity of the Raman scattered light D2 based on the normalized corrected spectrum of the selected sample. That is, the controller 100 acquires the peak intensity ratio of the peak intensity of the Raman scattered light D2 to the peak intensity of the reference Raman scattered light.

In step S111, the controller 100 determines whether or not the peak intensity of the Raman scattered light D2 has been acquired for all samples.

If it is not determined that the peak intensity of the Raman scattered light D2 has been acquired for all samples (NO in step S111), the process returns to step S101, and the controller 100 selects one sample to be processed from among the unselected samples.

On the other hand, if it is determined that the peak intensity of Raman scattered light D2 has been obtained for all samples (YES in step S111), in step 113, the controller 100 acquires a calibration curve that indicates the correlation based on the correlation between the heating temperature that can be regarded as the fictive temperature TF and the peak intensity of the Raman scattered light D2. The controller 100 uses this calibration curve as the calibration curve for the fictive temperature TF.

In step S115, the controller 100 acquires the spectrum of the optical fiber FB to be measured via the spectrophotometer SP.

In step S115, the controller 100 estimates the fictive temperature TF of the optical fiber FB to be measured based on the peak intensity of the Raman scattered light D2(intensity of peak P1), the peak intensity of the Raman scattered light ω3 (intensity of peak P2), and the peak intensity of the reference Raman scattered light due to Si—O—Si skeletal vibration (intensity of peak P3) in the acquired spectrum of the optical fiber FB. In this case, a calibration curve of the fictive temperature TF is used.

### Measurement Example by Measuring Device

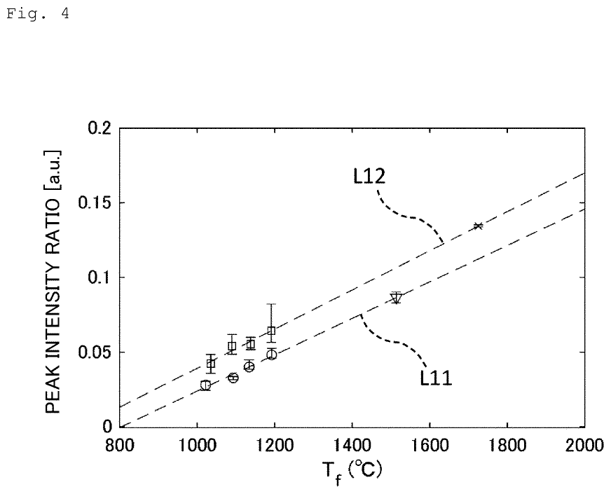

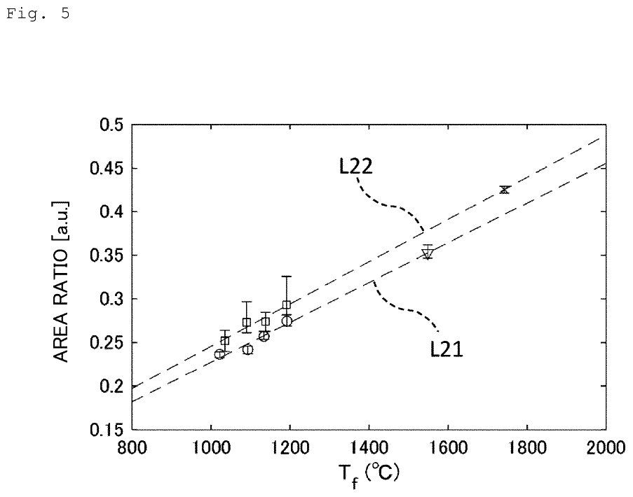

Next, an example of a measurement using the loss measuring device will be described. FIG. 4 is a diagram illustrating one example of the ratio of peak intensity to fictive temperature. FIG. 5 is a diagram illustrating one example of the ratio of peak area to fictive temperature based on related art.

To obtain the results shown in FIGS. 4 and 5, measurements were taken on multiple samples obtained by heating a coreless fiber made of anhydrous synthetic quartz with a cladding outer diameter of 125 um and a single-mode fiber with GeO₂ doped in the core region as an impurity at 1030 °C, 1080 °C, 1130 °C, and 1180 °C for 200 seconds and then rapidly cooling them. The samples were cooled sufficiently rapidly that the fictive temperature TF approximated the heating temperature.

The fiber end surface was irradiated with excitation light with a wavelength of 532 nm and a Raman image was measured. The Raman scattering spectrum was then evaluated based on the average value of a 7 μm square central region of the sample to be measured.

In FIG. 4, measurement points indicated by white circles are measurement points of the sample related to the coreless fiber, and the measurement points indicated by white squares are measurement points of the sample related to the single mode fiber. Each measurement point represents the average value of five measurement results. Error bars shown alongside the measurement points represent the maximum and minimum values among the five measurement results.

A straight line L11 in FIG. 4 indicates a calibration curve derived by the least squares method to fit the measurement points of the sample for a coreless fiber. The points indicated by white triangles indicate the estimated value of the fictive temperature TF for the coreless fiber under test (a coreless fiber with an unknown fictive temperature TF), derived based on straight line L11. The estimated value of the fictive temperature TF of the coreless fiber under test was 1514±31 °C.

A straight line L12 in FIG. 4 indicates a calibration curve derived by the least squares method to fit the measurement points of the sample for a single-mode fiber. The points indicated by X marks indicate the estimated value of the fictive temperature TF for the single-mode fiber under test (a single-mode fiber with an unknown fictive temperature TF), derived based on straight line L12. The estimated value of the fictive temperature TF of the single-mode fiber under test was 1726±7 °C.

A straight line L21 in FIG. 5 indicates a calibration curve derived by the least squares method to fit the measurement points of the sample for a coreless fiber. The points indicated by white triangles indicate the estimated value of the fictive temperature TF for the coreless fiber under test (a coreless fiber with an unknown fictive temperature TF), derived based on straight line L21. The estimated value of the fictive temperature TF of the coreless fiber under test was 1549±40 °C.

A straight line L22 in FIG. 5 indicates a calibration curve derived by the least squares method to fit the measurement points of the sample for a single-mode fiber. The points indicated by X marks indicate the estimated value of the fictive temperature TF for the single-mode fiber under test (a single-mode fiber with an unknown fictive temperature TF), derived based on straight line L22. The estimated value of the fictive temperature TF of the single-mode fiber under test was 1742±17 °C.

Therefore, for a coreless fiber, the variation in the estimated value of the fictive temperature TF based on the peak intensity ratio is ±2%, while the variation in the estimated value of the fictive temperature TF based on the conventional area ratio is ±2.6%. For a single-mode fiber, the variation in the estimated value of the fictive temperature TF based on the peak intensity ratio is ±0.4%, while the variation in the estimated value of the fictive temperature TF based on the conventional area ratio is ±1%.

Therefore, it can be seen that the estimation of fictive temperature TF based on the peak intensity ratio shown in the present embodiment has higher reproducibility than the conventional estimation of fictive temperature TF based on the area ratio. It can also be seen that the effect of improving reproducibility by the peak intensity ratio is even greater in a single-mode fiber doped with impurities. Further, since the peak intensity can be uniquely determined, it is not affected by peak shifts or fluctuations in the peak area acquisition range, and the estimation of fictive temperature TF based on the peak intensity ratio shown in the present embodiment can improve reproducibility.

### Effects of Embodiment

As described above, according to the present embodiment, an evaluating method and a measuring device for a fictive temperature of an optical fiber are related to a measuring device including a light source that irradiates an end face of an optical fiber mainly made of quartz glass with excitation light; a spectrophotometer that detects a spectrum of light emitted from the end face, and a controller that analyzes the spectrum. A peak intensity of Raman scattered light ω3 is subtracted from an intensity of the spectrum to calculate a corrected spectrum. A peak intensity of Raman scattered light D2 normalized by a peak intensity of reference Raman scattered light due to Si—O—Si skeletal vibration contained in the corrected spectrum is acquired. Then, the fictive temperature is estimated using a correlation established between the peak intensity of the Raman scattered light D2 and a fictive temperature of the quartz glass.

Accordingly, the fictive temperature of the glass that constitutes an optical fiber can be evaluated easily and with high accuracy. In particular, the estimation of fictive temperature TF based on the peak intensity ratio shown in the present embodiment has higher reproducibility than the conventional estimation of fictive temperature TF based on the area ratio. Since the peak intensity can be uniquely determined, it is not affected by peak shifts or fluctuations in the peak area acquisition range, and the estimation of fictive temperature TF can improve reproducibility.

Furthermore, the evaluating method and measuring device for the fictive temperature of the optical fiber according to the present embodiment may acquire the peak intensity of the Raman scattered light ω3 located near a wavenumber of 800 cm⁻¹. Therefore, the peak intensity can be uniquely determined, it is not affected by peak shifts or fluctuations in the peak area acquisition range, and the estimation of fictive temperature TF can improve reproducibility.

Furthermore, the evaluating method and measuring device for the fictive temperature of the optical fiber according to the present embodiment may acquire the peak intensity of the reference Raman scattered light located near a wavenumber of 400 cm⁻¹. Therefore, the peak intensity can be uniquely determined, it is not affected by peak shifts or fluctuations in the peak area acquisition range, and the estimation of fictive temperature TF can improve reproducibility.

Furthermore, the evaluating method and measuring device for evaluating the fictive temperature of the optical fiber according to the present embodiment may generate a plurality of samples by subjecting the optical fiber to a heat treatment at a different heating temperature for each sample and then rapidly cooling the sample, and obtain the peak intensity of the Raman scattered light D2 for each sample. A correlation between the heating temperature and the peak intensity of the Raman scattered light D2 may be used as the correlation.

Since each sample is rapidly cooled after the heating process, the heating temperature of the sample can be regarded as the fictive temperature TF of the sample. Therefore, the correlation between the heating temperature and the peak intensity of the Raman scattered light D2 can be obtained with high accuracy. Accordingly, the reproducibility of the estimation of the fictive temperature TF can be improved.

### Others

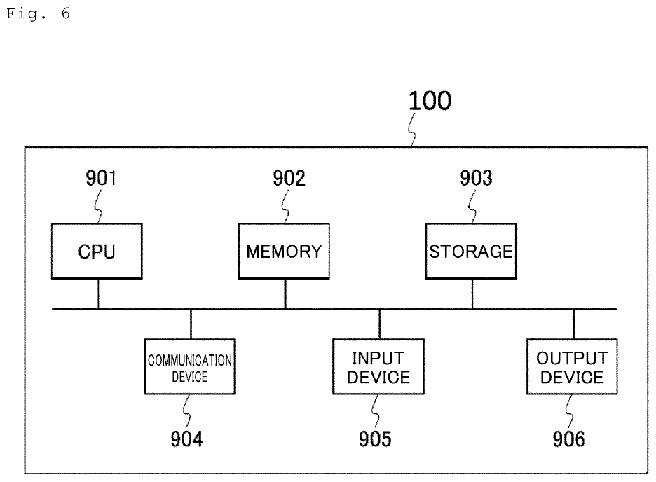

The controller 100 described above can be implemented using a general-purpose computer system including, for example, a CPU 901, a memory 902, a storage 903, a communication apparatus 904, an input apparatus 905, and an output apparatus 906, as illustrated in FIG. 6. The memory 902 and the storage 903 are storage devices. In the computer system, each function of the controller 100 is implemented by the CPU 901 executing a predetermined program loaded on the memory 902.

The controller 100 may be implemented using one computer. The controller 100 may be implemented using a plurality of computers. The controller 100 may be a virtual machine mounted on a computer. A program for the controller 100 can be stored in a computer-readable recording medium such as an HDD, SSD, USB memory, CD, and DVD. The program for the controller 100 can also be distributed via a communication network.

Each function described in the above embodiments may be implemented by at least one processing circuit. The processing circuits include programmed processors, electrical circuits, and even devices such as application specific integrated circuits (ASICs), and circuit components arranged to perform the described functions.

The present disclosure has been described above in accordance with the embodiments, but the present disclosure is not limited to these descriptions, and it will be apparent to those skilled in the art that various modifications and improvements are allowable without departing from the present disclosure. The descriptions and drawings that form part of the present disclosure should not be understood as limiting the present invention. Various alternative embodiments, examples, and operational techniques will be apparent to a person skilled in the art from the present disclosure.

Of course, the present disclosure encompasses various embodiments not described here. Thus, the technical scope of the present disclosure is only defined by invention specifying matters in the claims that are appropriate from the above description.

### REFERENCE SIGNS LIST

100 controller
ES end face
FB optical fiber
LD light source
R1 excitation light
R2 scattered light
SP spectrophotometer
TF fictive temperature

1. An evaluating method for evaluating a fictive temperature of an optical fiber, the method being related to a measuring device,
wherein the measuring device includes
a light source that irradiates an end face of an optical fiber mainly made of quartz glass with excitation light,
a spectrophotometer that detects a spectrum of light emitted from the end face, and
a controller that analyzes the spectrum,
wherein the controller is configured to:
calculate a corrected spectrum by subtracting a peak intensity of Raman scattered light ω3 due to Si—O stretching vibration contained in the spectrum from an intensity of the spectrum;
normalize the corrected spectrum based on a peak intensity of reference Raman scattered light due to Si—O—Si skeletal vibration contained in the corrected spectrum to acquire a peak intensity of Raman scattered light D2 due to a 3-membered silica ring contained in the normalized corrected spectrum; and
estimate the fictive temperature using a correlation established between the peak intensity of the Raman scattered light D2 and a fictive temperature of the quartz glass.

2. The evaluating method according to claim 1, wherein
the controller is configured to acquire a peak intensity of Raman scattered light ω3located in the vicinity of a wavenumber of 800 cm⁻¹.

3. The evaluating method according to claim 1, wherein
the controller is configured to acquire the peak intensity of the reference Raman scattered light located in the vicinity of a wavenumber of 400 cm⁻¹.

4. The evaluating method according to claim 1, wherein
the optical fiber is subjected to a heat treatment at a different heating temperature for each sample and then rapidly cooled to generate a plurality of samples,
the peak intensity of the Raman scattered light D2 is acquired for each sample, and
the controller is configured to use a relationship between the heating temperature and the peak intensity of the Raman scattered light D2 as the correlation.

5. A measuring device for measuring a fictive temperature of an optical fiber, the device comprising:
a light source that irradiates an end face of an optical fiber mainly made of quartz glass with excitation light;
a spectrophotometer that detects a spectrum of light emitted from the end face, and
a controller that analyzes the spectrum,
wherein the controller is configured to:
calculate a corrected spectrum by subtracting a peak intensity of Raman scattered light ω3 due to Si—O stretching vibration contained in the spectrum from an intensity of the spectrum;
normalize the corrected spectrum based on a peak intensity of reference Raman scattered light due to Si—O—Si skeletal vibration contained in the corrected spectrum to acquire a peak intensity of Raman scattered light D2 due to a 3-membered silica ring contained in the normalized corrected spectrum; and
estimate the fictive temperature using a correlation established between the peak intensity of the Raman scattered light D2 and a fictive temperature of the quartz glass.
